(19) United States
(12) Patent Application Publication
(10) Pub. No.: US 2026/0139455 A1
(43) Pub. Date: May 21, 2026

(54) Hydraulic Control System for a Working Machine

(71) Applicant: Caterpillar SARL, Geneva (CH)

(72) Inventors: Hideki NAKAJIMA, Akashi-shi (JP); Toshikazu KOGA, Akashi-shi (JP)

(73) Assignee: Caterpillar SARL, Geneva (CH)

(21) Appl. No.: 19/118,242

(22) PCT Filed: Sep. 29, 2023
(86) PCT No.: PCT/EP2023/025414

§ 371 Date: Apr. 3, 2025

(30) Foreign Application Priority Data
Oct. 3, 2022 (JP) 2022-159681

(51) Int. Cl. E02F 9/22; E02F 3/32; E02F 3/42; E02F 3/43; F15B 11/17; F15B 15/18

(52) U.S. Cl. CPC E02F 9/2203; E02F 9/2253; E02F 9/2292; E02F 9/2296; F15B 11/17; F15B 15/18; E02F 3/32; E02F 3/425; E02F 3/435; E02F 9/2285

(57) ABSTRACT

Problem: In a hydraulic control system including a prime motor, a plurality of variable-capacity hydraulic pumps driven by the prime motor, and a plurality of hydraulic actuators driving the hydraulic pumps as a hydraulic source, merging of the discharged oil of the hydraulic pump is reduced to reduce the decrease in efficiency and operability caused by the merging. Solution: A controller is provided to control the pump capacity of the hydraulic pumps and the rotational speed of the prime motor, and the controller is provided with a reference pump flow rate setting unit that sets a reference pump flow rate, a target pump flow rate setting unit that sets a target pump flow rate of each hydraulic pump for each hydraulic pump according to operation of a manipulator, and a pump flow rate control unit that, when the target pump flow rate of any hydraulic pumps exceeds the reference pump flow rate, maximizes the pump capacity of the hydraulic pump, and increases the rotational speed of the prime motor, thereby increasing the pump flow rate to be greater than the reference pump flow rate.

### TECHNICAL FIELD

The present invention relates to the technical field of hydraulic control system used in working machines such as a hydraulic excavator.

### BACKGROUND

Generally, a work machine such as a hydraulic excavator is provided with a prime motor such as an engine or an electric motor, a plurality of hydraulic pumps driven by the prime motor, and a plurality of hydraulic actuators using the hydraulic pumps as a hydraulic source. In such a hydraulic system, in a case of a large flow rate hydraulic actuator in which the hydraulic actuator requires a hydraulic oil supplied from a plurality of hydraulic pumps, or in the case of complex operation in which the plurality of hydraulic actuators are operated at the same time, the hydraulic oil from the plurality of hydraulic pumps may be merged to supply the hydraulic actuator, but in this case, the hydraulic interference caused by the merging may cause a decrease in efficiency or deterioration in operability. For example, when hydraulic oil from two hydraulic pumps is fed to a hydraulic actuator with different load pressure, the efficiency is reduced because the discharge pressure of both hydraulic pumps needs to be increased to the pressure of the hydraulic actuator on the high load side in order to avoid the flow of hydraulic oil to the hydraulic actuator on the low load side.

On the other hand, as a technique for improving operability during complex operation, there is a known technique that prioritizes the hydraulic oil supply order from the first and second hydraulic pumps (a front pump, a rear pump) to each hydraulic actuator according to the combination of hydraulic actuators that are simultaneously operated, so as to control the hydraulic oil supply timing and the hydraulic oil supply amount independently (see, for example, Patent Document 1).

There is also a technique that provides a variable-capacity first hydraulic pump driven by an engine and supplying hydraulic oil to a first hydraulic actuator, a second and third hydraulic pumps driven by the engine via a stepless transmission and supplying hydraulic oil to a second and third hydraulic actuators, respectively, and a controller that changes the capacity of the first hydraulic pump and a variable speed ratio of each stepless transmission according to an operation amount (see, for example, Patent Document 2).

### PRIOR ART DOCUMENTS

### Patent Documents

Patent Document 1: JPH 08-23768A

Patent Document 2: JP 2016-205451A

### SUMMARY OF THE INVENTION

### Problems to be Solved by the Invention

However, the invention of the Patent Document 1 is configured to be supplied with hydraulic oil from both the first and second hydraulic pumps to any hydraulic actuator that is operated simultaneously during complex operation, and for a bucket cylinder that is supplied with hydraulic oil only from the first hydraulic pump during single operation, to be supplied with hydraulic oil from the second hydraulic pump or from both the first and second hydraulic pumps during the complex operation. In addition, for a boom cylinder and an arm cylinder, which are large flow rate hydraulic actuators, when the supply flow rate exceeds half of the maximum flow rate during the single operation, hydraulic oil is supplied from both the first and second hydraulic pumps. In other words, in Patent Document 1, merging of the discharged oil of the first and second hydraulic pumps is frequently performed. Therefore, while it is impossible to avoid the decrease in efficiency and operability caused by merging, there is a problem that the circuit for supplying merging oil to hydraulic actuators that are not large flow actuators is required, and the circuit becomes complicated.

On the other hand, the invention of Patent Document 2 is configured to be that basically one hydraulic pump is a hydraulic supply source of one or two hydraulic actuators, that is, each hydraulic pump alone is configured to be capable of supplying the maximum supply flow rate of one or two hydraulic actuators. For this reason, a large capacity hydraulic pump is required, and there are unfavorable problems in cost and space, which are the problems to be solved by the present invention.

### Means for Solving the Problem

The present invention has been devised with an aim of solving these problems in view of the above-mentioned realities. The invention of claim 1 relates to a hydraulic control system of a working machine, wherein the hydraulic control system comprises a prime motor, a plurality of variable-capacity hydraulic pumps driven by the prime motor, a plurality of hydraulic actuators driving at least one of the hydraulic pumps as a hydraulic source, operating means for each hydraulic actuator operated to drive each hydraulic actuator, and a plurality of control valves controlling supply of hydraulic oil from the hydraulic pump to each hydraulic actuator, and is provided with a controlling device to control actuation of the control valve, pump capacity of the hydraulic pump and a rotational speed of the prime motor; wherein the controlling device comprises: a reference pump flow rate setting means that sets a pump flow rate of the hydraulic pump when the pump capacity of the hydraulic pump is a maximum and the rotational speed of the prime motor is a preset reference rotational speed as a reference pump flow rate; a target pump flow rate setting means that sets a target pump flow rate of each hydraulic pump for each hydraulic pump depending on operation of the operating means for each hydraulic actuator within a range in which the pump flow rate of each hydraulic pump does not exceed a preset maximum pump flow rate; and a pump flow rate control means that, when the target pump flow rate of any one of the hydraulic pumps set by the target pump flow rate setting means exceeds the reference pump flow rate, maximizes the pump capacity of the one of the hydraulic pumps and increases the rotational speed of the prime motor to be greater than the reference rotational speed, thereby increasing the pump flow rate of the one of the hydraulic pumps to be greater than the reference pump flow rate.

The invention of claim 2, wherein in claim 1, a first hydraulic pump and a second hydraulic pump are comprised as the hydraulic pumps, and a large flow rate hydraulic actuator supplied hydraulic oil from both the first and second hydraulic pumps at a time of maximum flow rate supply is comprised as the hydraulic actuator; the controller controls any one of the first and second hydraulic pumps to a main pump and supply hydraulic oil from only the main pump until a flow rate supplied to the large flow rate hydraulic actuator reaches a set flow rate which is set to exceed the reference pump flow rate, when the operating means for the large flow rate hydraulic actuator is operated alone, and to be supplied with the hydraulic oil from both the first and second hydraulic pumps when the flow rate exceeds the set flow rate; and the target pump flow rate setting means sets the target pump flow rate of the main pump to exceed the reference pump flow rate depending on the supply flow rate to the large flow rate hydraulic actuator from the main pump.

The invention of claim 3, wherein in claim 2, a first large flow rate hydraulic actuator is comprised, using the first hydraulic pump as the main pump, and a second large flow rate hydraulic actuator is comprised, using the second hydraulic pump as the main pump; when the operating means for the first and second large flow rate hydraulic actuators are operated simultaneously, the controller controls to supply the hydraulic oil from each main pump to the first and second large flow rate hydraulic actuators, respectively; and the target pump flow rate setting means sets the target pump flow rate of the first and second hydraulic pumps for each hydraulic pump depending on the operation amount of the operating means for the first and second large flow rate hydraulic actuators.

The invention of claim 4, wherein in claim 1, the work machine comprises a traveling body having a left traveling body and a right traveling body, a working device mounted on the traveling body, a first hydraulic pump and a second hydraulic pump as the hydraulic pumps, a left traveling motor and a right traveling motor, as the hydraulic actuators, driving the left traveling body and the right traveling body, respectively, and a plurality of working hydraulic actuators driving the working device; when the left and right travel motors and the operating means for the working hydraulic actuator are simultaneously operated, the controller controls a control valve to supply the hydraulic oil from the first hydraulic pump to the left and right traveling hydraulic motors and the hydraulic oil from the second hydraulic pump to the working hydraulic actuator; and the target pump flow rate setting means sets the target pump flow rate of the second hydraulic pump to be greater than the reference pump flow rate.

### Effect of the Invention

According to the invention of claim 1, it is possible to reduce the decrease in efficiency and operability, and complexity of the circuit caused by merging, and it is not necessary to provide a large-capacity hydraulic pump.

According to the invention of claim 2, it is possible to reduce the frequency of the merging even with the large flow rate hydraulic actuators supplied with the hydraulic oil from both the first and second hydraulic pumps at the time of maximum flow supply.

According to the invention of claim 3, when the first and second large flow rate hydraulic actuators are driven at the same time, the merging of the discharged oil of the first and second hydraulic pumps can be eliminated, even if these are large flow rate hydraulic actuators supplied with the hydraulic oil from both the first and second hydraulic pumps at the time of maximum flow supply.

According to the invention of claim 4, the left and right traveling motors and the working hydraulic actuator can be supplied with hydraulic oil independently without hydraulic interference from each other, and the flow rate supplied to the working hydraulic actuator can be greater than the reference pump flow rate, which can contribute to improving the work efficiency.

### BRIEF DESCRIPTION OF THE DRAWINGS

FIG. 1 is a hydraulic circuit diagram illustrating a first embodiment.

FIG. 2 is a side view of a hydraulic excavator.

FIG. 3 is a block diagram illustrating input/output of a controller.

FIG. 4 is a tabular diagram illustrating set examples of a target pump flow rate.

FIG. 5 is a diagram illustrating, when the stick manipulator is operated alone, the relationship among the operation amount of the manipulator, a target supply flow rate from the first and second hydraulic pumps to a stick cylinder, opening area of the stick's flow rate control valve, and opening area of a supply valve passage for a stick's directional switching valve.

FIG. 6 is a hydraulic circuit diagram illustrating a second embodiment.

### DETAILED DESCRIPTION

Embodiments of the present invention will be described below with reference to the drawings.

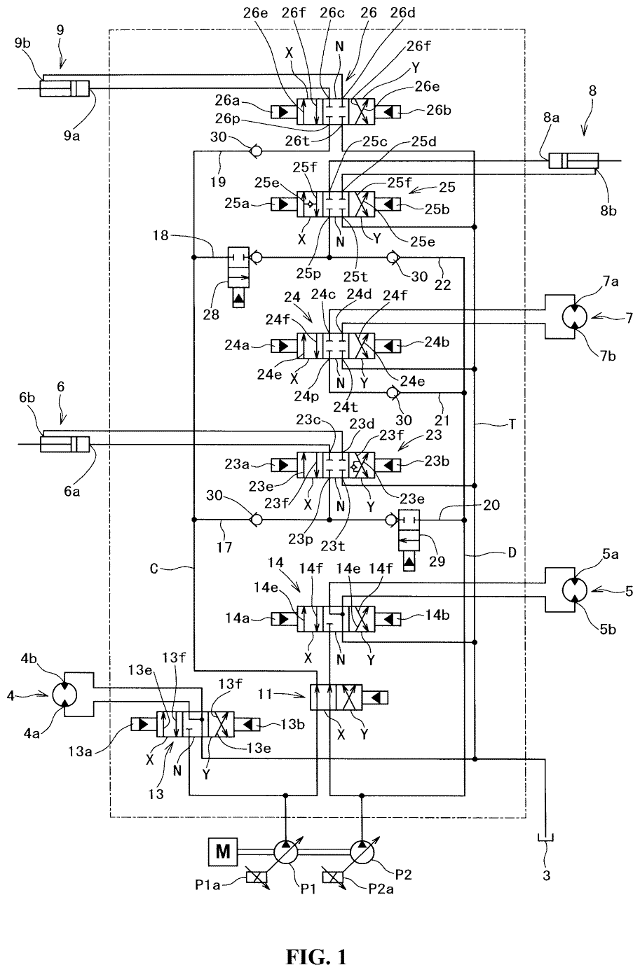

First of all, FIG. 1 is a hydraulic circuit diagram illustrating the first embodiment of the hydraulic control system of a hydraulic excavator in which this invention has been implemented. In the FIG. 1, M represents a prime motor; P1, P2 respectively represent a variable-capacity hydraulic pump driven by the prime motor; P1a, P2a respectively represent a variable-capacity means changing the capacities of the hydraulic pumps P1, P2 based on a control signal transmitted from controller 10 mentioned later; 3 represents an oil tank; 4 represents a left traveling motor; 5 represents a right traveling motor; 6 represents a boom cylinder; 7 represents a swiveling motor; 8 represents a stick cylinder; and 9 represents a bucket cylinder. The left traveling motor 4, the right traveling motor 5, the boom cylinder 6, the swiveling motor 7, the stick cylinder 8, and the bucket cylinder 9 are hydraulic actuators using the hydraulic pumps P1, P2 as hydraulic supply sources. In these hydraulic actuators, the boom cylinder 6 and the stick cylinder 8 are hydraulic actuators using both hydraulic pumps P1, P2 as hydraulic supply sources and correspond to the large flow rate hydraulic actuator of this invention. In addition, in the present embodiment, an electric motor driven by a power supply from a battery (not shown) is used as the prime motor M, and drive shafts of the hydraulic pumps P1 and P2 are connected to an output shaft of the electric motor.

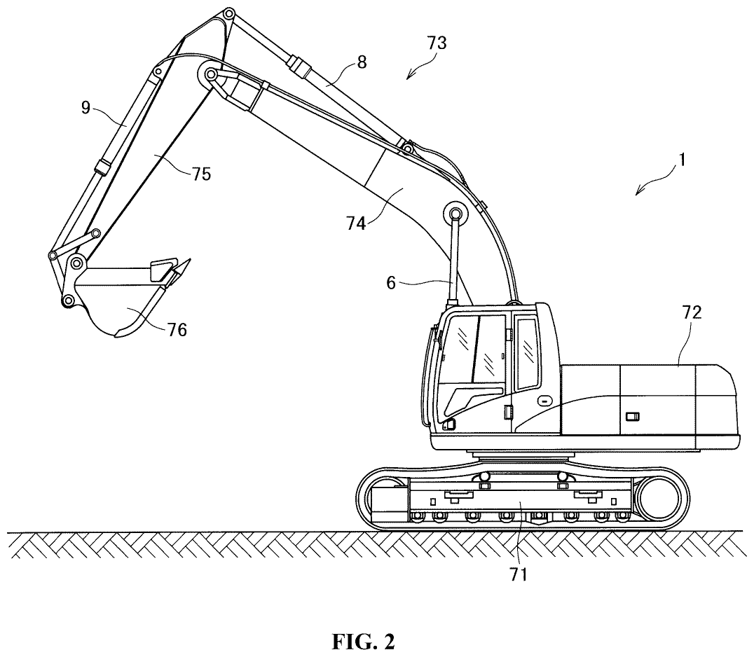

It should be noted that the hydraulic excavator 1 is an example of the working machine of the present invention, and as shown in FIG. 2, the hydraulic excavator is configured to include a lower traveling body 71 with left and right traveling bodies respectively driven by the left and right traveling motors 4, 5; an upper swinging body 72 that is pivotally supported by the lower traveling body 71 and pivotally driven by the swiveling motor 7; and a front work machine 73 mounted on the upper swiveling body 72. The front work machine 73 is configured to include a boom 74 being vertically freely supported on the upper swiveling body 72 and driven by the boom cylinder 6; a stick 75 swingably axially supported on a tip of the boom 74 and driven by the stick cylinder 8; and a bucket 76 mounted on a tip of the stick 75 and driven by the bucket cylinder 9. The lower traveling body 71 and the upper swinging body 72 constitute the traveling body of the present invention. In addition, the front working machine 73 corresponds to the working device of the present invention, and the boom cylinder 6, the stick cylinder 8, and the bucket cylinder 9 correspond to the working hydraulic actuator of the present invention.

The hydraulic pump P1 is connected to a pump line C via a traveling straight-forward valve 11 at a first position X mentioned later, and is connected to a left traveling directional switching valve 13. Also, the hydraulic pump P2 is connected to a pump line D, and is connected to a right traveling directional switching valve 14 via the traveling straight-forward valve 11 at the first position X.

The traveling straight-forward valve 11 is a two-position switching valve that switches to a first position X and a second position Y based on a control signal output from the controller 10. With the traveling straight-forward valve 11 located at the first position X, the discharged oil of the hydraulic pump P1 is supplied to the pump line C and the left traveling directional switching valve 13, and the discharged oil of the hydraulic pump P2 is supplied to the pump line D and the right traveling directional switching valve 14. In addition, with the traveling straight-forward valve 11 located in the second position Y, the discharged oil of the hydraulic pump P1 is supplied to both the left and right traveling directional switching valves 13, 14, and the discharged oil of the hydraulic pump P2 is supplied to both the pump lines C, D. The controller 10 then controls the traveling straight-forward valve 11 to be positioned in the first position X if only the left and right traveling manipulators (not shown) are operated, or if only other hydraulic actuator manipulators (boom, swiveling, stick, bucket manipulators, which are not shown) other than the traveling manipulators are operated. On the other hand, when both the left and right traveling manipulators are operated to perform straight travel, and other hydraulic actuator manipulators are operated at the same time, a control signal is output to switch the traveling straight-forward valve 11 to the second position Y. As a result, when only the left and right traveling manipulators are operated, with the traveling straight-going valve 11 located at the first position X, the discharged oil of the hydraulic pumps P1 and P2 is supplied to the left and right traveling motors 4 and 5 via the left and right traveling directional switching valves 13 and 14, respectively. On the other hand, if the left and right traveling manipulators are operated at the same time as the other hydraulic actuator manipulators, the discharge flow rate of the hydraulic pump P1 can be distributed only by the left and right traveling motors 4 and 5 to equalize the supply flow rate to both the traveling motors 4 and 5, and the discharge flow rate of the hydraulic pump P2 can be supplied to the other hydraulic actuators. In the following description, in the absence of a specific exclusion, it will be explained that the traveling straight-forward valve 11 is located at the first position X; that is, the discharged oil of the hydraulic pump P1 is supplied to the pump line C and the left traveling directional switching valve 13, and the discharged oil of the hydraulic pump P2 is supplied to the pump line D and the right traveling directional switching valve 14. In addition, the manipulators for the left and right traveling, boom, swinging, stick, and bucket correspond to the operating means of the present invention.

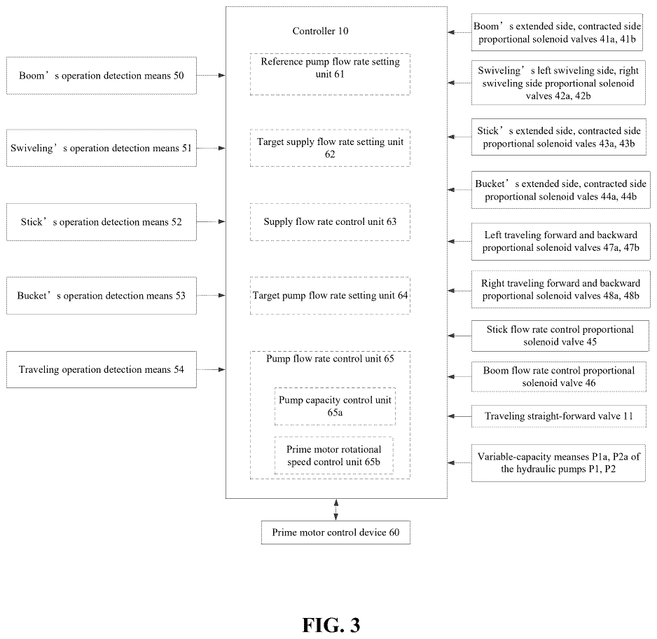

The left and right traveling directional switching valves 13, 14 are a closed center spool valve switching controlling the supply and discharge flow rates for the left and right traveling motors 4, 5 as well as switching the supply and discharge directions, and comprise a forward side and backward side pilot ports 13a, 13b, 14a, and 14b connected to a left traveling forward side proportional solenoid valve 47a, a left traveling backward side proportional solenoid valve 47b, a right traveling forward side proportional solenoid valve 48a, a right traveling backward side proportional solenoid valve 48b (shown in FIG. 3) for outputting the pilot pressure based on the control signal output from the controller 10. Also, when no pilot pressure is input into both the forward side and backward side pilot ports 13a, 13b, 14a, and 14b, the left and right traveling directional switching valves 13 and 14 are positioned in a neutral position N where the supply and discharge of the left and right traveling motors 4 and 5 are not controlled. When the pilot pressure is input into the forward pilot ports 13a, 14a, the left and right traveling directional switching valves 13 and 14 are switched to a forwarding side operating position X, to open supply valve passages 13e, 14e to supply the discharged oil of the hydraulic pumps P1, P2 to the forward side ports 4a, 5a of the left and right traveling motors 4 and 5, and at the same time, to open discharge valve passages 13f, 14f to flow the discharged oil from the backward ports 4b, 5b to the oil tank 3. In addition, when the pilot pressure is inputted to the backward pilot ports 13b, 14b, the left and right traveling directional switching valves 13 and 14 switch to the backward side operating position Y to open the supply valve passages 13e, 14e to supply the discharged oil of the hydraulic pumps P1, P2 to the backward ports 4b, 5b of the left and right traveling motors 4 and 5, and at the same time, to open the discharge valve passages 13f, 14f to flow the discharged oil from the forward side ports 4a, 5a to the oil tank 3. The supply flow rate and the discharge flow rate for the left and right traveling motors 4 and 5 when being positioned in the forward side operating position X and the backward side operating position Y are controlled by the opening area of the supply valve passages 13e, 14e, and the discharge valve passages 13f and 14f, and the opening area is controlled to increase and decrease depending on the spool's move position with the increase and decrease of pilot pressure inputted to the forward or backward pilot ports 13a, 13b, 14a, 14b from the traveling proportional solenoid valves. Then, the controller 10 controls the left traveling forward side proportional solenoid valve 47a, the left traveling backward side proportional solenoid valve 47b, the right traveling forward side proportional solenoid valve 48a and the right traveling backward side proportional solenoid valve 48b to output the pilot pressure that increases or decreases according to the operation amount of the traveling manipulators when the left and right traveling manipulators are operated, so that the left and right traveling motors 4, 5 can be driven at a speed corresponding to the operation amount of the traveling manipulators.

On the other hand, from the pump line C connected to the hydraulic pump P1, a boom's main-side supply oil passage 17, a stick's subside supply oil passage 18, and a bucket's supply oil passage 19 are branched in parallel with each other, and from the pump line D connected to the hydraulic pump P2, a boom's subside supply oil passage 20, a swiveling's supply oil passage 21, and a stick's main-side supply oil passage 22 are branched in parallel with each other. The boom's main-side oil supply oil passage 17 and the boom's subside supply oil passage 20 are oil passages connecting the hydraulic pumps P1 and P2 to the pump ports 23p of the boom's directional switching valve 23 described later, and the stick's main-side supply oil passage 22 and the stick's subside supply oil passage 18 are oil passages connecting the hydraulic pumps P2 and P1 to the pump port 25p of the stick's directional switching valve 25, respectively. The swiveling's supply oil passage 21 is an oil passage connecting the hydraulic pump P2 to the pump port 24p of the swiveling's directional switching valve 24, and the bucket's supply oil passage 19 is an oil passage connecting the hydraulic pump P1 to the pump port 26p of the bucket's directional switching valve 26.

The stick's subside supply oil passage 18 is provided with the stick's flow rate control valve 28, which controls to feed a supply flow from the hydraulic pump P1 to the stick's directional switching valve 25. Also, the boom's subside supply oil passage 20 is provided with a boom's flow rate control valve 29 to control the supply flow rate from the hydraulic pump P2 to the boom's directional switching valve 23. The stick's flow rate control valve 28 and the boom's flow rate control valve 29 are poppet valves operated by the pilot flow rate proportional solenoid valve 45 and a flow proportional solenoid valve 46 (shown in FIG. 3) which are operated on the basis of a control signal output from the controller 10 to control the flow rate. It has a reverse flow preventing function, allowing the flow of oil from the hydraulic pumps P1 and P2 to the stick's directional switching valve 25 and the boom's directional switching valve 23, but the reverse flow is prevented.

On the other hand, a flow rate control valve, such as the stick's flow rate control valve 28 and the boom's flow rate control valve 29 described above, is not provided in the boom's main-side supply oil passage 17, the bucket's supply oil passage 19, the swiveling's supply oil passage 21, and the stick's main-side supply oil passage 22, and the flow rate from the hydraulic pump Pl or the hydraulic pump P2 is supplied to the boom's directional switching valve 23, the bucket's directional switching valve 26, the swiveling's directional switching valve 24, and the stick's directional switching valve 25 without controlling the flow rate. In addition, a check valve 30 is respectively provided in the boom's main-side supply oil passage 17, the bucket's supply oil passage 19, the swiveling's supply oil passage 21, and the stick's main-side supply oil passage 22, and the flow of oil from the hydraulic pumps P1 and P2 to the boom's directional switching valve 23, the bucket's directional switching valve 26, the swiveling's directional switching valve 24, and the stick's directional switching valve 25 is allowed, but the backflow is prevented.

Thus, the pump port 23p on the boom's directional switching valve 23 can be supplied the hydraulic oil from the hydraulic pump P1 via the boom's main-side supply oil passage 17 and the hydraulic oil from the hydraulic pump P2 via the boom's subside supply oil passage 20 at the same time. Also, the hydraulic oil from hydraulic pump P2 is to be supplied to the boom's directional switching valve 23 in a state (including a cut-off state) of the flow rate controlled by the boom's flow rate control valve 29 disposed in the boom's subside supply oil passage 20. The pump port 25p of the stick's directional switching valve 25 is to be supplied with the hydraulic oil from the hydraulic pump P2 via the stick's main-side supply oil passage 22 and the hydraulic oil from the hydraulic pump P1 via the stick's subside supply oil passage 18 at the same time, and the hydraulic oil from the hydraulic pump P1 is to be supplied to the stick's directional switching valve 25 in a state (including a cut-off state) of the flow rate controlled by the stick's flow rate control valve 28 disposed in the stick's subside supply oil passage 18.

Next, the explanation is provided about the boom's, swiveling's, stick's and bucket's directional switching valves 23 to 26.

First, an explanation is provided about the swiveling's, bucket's directional switching valves 24, 26 where the hydraulic oil is supplied from either one of the hydraulic pumps P1, P2. The swiveling's directional switching valve 24 is a closed center spool valve for controlling the supply and discharge flow rates of the swiveling motor 7 as well as switching its supply and discharge directions. The swiveling's directional switching valve 24 includes left, right swiveling pilot ports 24a, 24b respectively connected to the left, right swiveling proportional solenoid valves 44a, 44b (shown in FIG. 3) for outputting pilot pressure based on a control signal output from controller 10; a pump port 24p connected to the swiveling's supply oil passage 21; a tank port 24t connected to a tank line T to the oil tank 3; a first actuator port 24c connected to a left swiveling port 7a on the swiveling motor 7; and a second actuator port 24d connected to a right swiveling port 7b on the swiveling motor 7. Also, when no pilot pressure is input into both the left, right swiveling pilot ports 24a, 24b, the swiveling's directional switching valve 24 is positioned at the neutral position N where the supply and discharge of the swiveling motor 7 is not controlled. When the pilot pressure is input into the left swiveling pilot port 24a, the valve 24 is switched to a left swiveling operating position X to open a supply valve passage 24e from a pump port 24p to the first actuator port 24c and open a discharge valve passage 24f from the second actuator port 24d to the tank port 24t. Also when the pilot pressure is input into the right swiveling pilot port 24b, the valve 24 is configured to be switch to a right swiveling operating position Y to open the supply valve passage 24e from the pump port 24p to the second actuator port 24d and open the discharge valve passage 24f from the first actuator port 24c to the tank port 24t. When the valve 24 is positioned at left or right swiveling operating position X or Y, the supply and discharge flow rates for the swiveling motor 7 are to be controlled by the opening area of the supply and discharge valve passages 24e, 24f, and the opening area is controlled to be increased or decreased depending on the spool's move position with the increase or decrease of pilot pressure output from the left and right swiveling proportional solenoid valves 42a, 42b to the left and right swiveling pilot ports 24a, 24b.

The bucket's directional switching valve 26 is a closed center spool valve for controlling the supply and discharge flow rates of bucket cylinder 9 as well as switching the supply and discharge directions. The valve 26 has an extended side pilot port 26a and a contracted side pilot port 26b respectively connected to a bucket's extended side proportional solenoid valve 44a and contracted side proportional solenoid valve 44b (shown in FIG. 3) for outputting pilot pressure based on a control signal output from the controller 10, a pump port 26p connected to the bucket's supply oil passage 19, a tank port 26t connected to the tank line T, a first actuator port 26c connected to a head side port 9a on the bucket cylinder 9, and a second actuator port 26d connected to a rod side port 9b on the bucket cylinder 9. The bucket's directional switching valve 26 has the same structure as the swiveling's directional switching valve 24 mentioned above. When the valve 26 switches from a neutral position N to an extended or contracted side operating position X or Y, the valve 26 is configured to open a supply valve passage 26e from the pump port 26p to the actuator port 26c or 26d and open a discharge valve passage 26f from the actuator port 26d or 26c to the tank port 26t, and control the supply and discharge flow rates depending on the opening area of the supply and discharge valve passages 26e, 26f of the bucket cylinder 9. The opening area is controlled to be increased or decreased depending on the spool's move position with the increase or decrease of the pilot pressure output from the bucket's extended side, contracted side proportional solenoid valves 44a, 44b.

Next, an explanation is provided about the boom's, stick's directional switching valves 23, 25 where the hydraulic oil is supplied from both first and second hydraulic pumps P1, P2. The bucket's directional switching valve 25 is a closed center spool valve for controlling the supply and discharge flow rates of the stick cylinder 10 as well as switching the supply and discharge directions. The valve 25 has an extended side pilot port 25a and a contracted side pilot port 25b respectively connected to bucket's extended side and contracted side proportional solenoid valves 43a, 43b (shown in FIG. 3) for outputting pilot pressure based on a control signal output from the controller 10, a pump port 25p connected to the stick's main-side supply oil passage 22 and the stick's subside supply oil passage 18, a tank port 25t connected to the tank line T, a first actuator port 25c connected to a head side port 8a of the stick cylinder 8, and a second actuator port 25d connected to a rod side port 8b of the stick cylinder 8. When the pilot pressure is not input into both the extended side and contracted side pilot ports 25a, 25b, the stick's directional switching valve 25 is positioned at a neutral position N where the supply and discharge for the stick cylinder 8 is not controlled. When the pilot pressure is input into the extended side pilot port 25a, the valve 25 is configured to be switched to an extended side operating position X to open a supply valve passage 25e from the pump port 25p to the first actuator port 25c and open a discharge valve passage 25f from the second actuator port 25d to the tank port 25t. When the pilot pressure is input into the contracted side pilot port 25b, the valve 25 is configured to be switched to the contracted side operating position Y to open the supply valve passage 25e from the pump port 25p to the second actuator port 25d and open the discharge valve passage 25f from first actuator port 25c to the tank port 25t. The opening area of the supply valve passage 25e and the discharge valve passage 25f is controlled to be increased or decreased depending on the spool's move position moved by the pilot pressure output from the stick's extended side proportional solenoid valve 43a and contracted side proportional solenoid valve 43b, and the discharge flow rate from the stick cylinder 8 are to be controlled by the opening area of the discharge valve passages 25f. When the stick's flow rate control valve 28 closes the stick's subside supply oil passage 18, the supply flow rate to the stick cylinder 8 is to be controlled by the opening area of the supply valve passage 25e on the stick's directional switching valve 25. When the stick's flow rate control valve 28 opens the stick's subside supply oil passage 18, the supply flow rate to the stick cylinder 8 is to be controlled by the opening area of the stick's flow rate control valve 28 and the opening area of the supply valve passage 25e of the stick's directional switching valve 25.

The boom's directional switching valve 23 is a closed center spool valve for controlling the supply and discharge flow rates of the boom cylinder 6 as well as switching the supply and discharge directions. The valve 23 has an extended side pilot port 23a and a contracted side pilot port 23b respectively connected to boom's extended side and contracted side proportional solenoid valves 41a, 41b (shown in FIG. 3) for outputting pilot pressure based on a control signal output from the controller 10, a pump port 23p connected to the boom's main-side supply oil passage 17 and the boom's subside supply oil passage 20, a tank port 23t connected to the tank line T, a first actuator port 23c connected to a head side port 6a on the boom cylinder 6, and a second actuator port 23d connected to a rod side port 6b on the boom cylinder 6. The boom's directional switching valve 23 has a similar structure to the aforementioned stick's directional switching valve 25 and is configured to open a supply valve passage 23e from the pump port 23p to the actuator port 23c or 23d and open a discharge valve passage 24f from the actuator port 23d or 23c to the tank port 23t by switching from a neutral position N to an extended side actuation position X and a contracted side actuation position Y. The opening area of the supply and discharge valve passages 23e and 23f is controlled to be increased or decreased depending on the spool's move position moved by the pilot pressure output from the boom's extended side and contracted side proportional solenoid valves 41a, 41b, and the discharge flow rate from the boom cylinder 6 is to be controlled by the opening area of the discharge valve passage 23f. When the boom's flow rate control valve 29 closes the boom's subside supply oil passage 20, the supply flow rate to the boom cylinder 6 is to be controlled by the opening area of the supply valve passage 23e of the boom's directional switching valve 23. When the boom's flow rate control valve 29 opens the boom's subside supply oil passage 20, the supply flow rate to the boom cylinder 6 is to be controlled by the opening area of the boom's flow rate control valve 29 and the opening area of the supply valve passage 23e on the boom's directional switching valve 23.

Note that the traveling straight-forward valve 11, left and right traveling, boom's, swivel's, stick's, bucket's directional switching valves 13, 14, 23-26, boom's and stick's flow rate control valves 28, 29 correspond to the control valves of the present invention.

Furthermore, in the present embodiment, the hydraulic pumps P1, P2 correspond to the pumps or the first and second hydraulic pumps of the present invention, and the boom cylinder 6 and the stick cylinder 8 are hydraulic actuators corresponding to the large flow rate hydraulic actuators or the first and second large flow rate hydraulic actuators of the present invention, as described above, and both the first and second hydraulic pumps of the present invention are used as hydraulic supply sources. In addition, the main pump of the present invention is a hydraulic pump to which the main-side supply oil passage (the boom's main-side supply oil passage 17, the stick's main-side supply oil passage 22) is connected. In the present embodiment, the main pump of the boom cylinder 6 is the hydraulic pump P1, and the main pump of the stick cylinder 8 is the hydraulic pump P2.

As shown in the block diagram of FIG. 3, the controller 10 (corresponding to the control means in this invention) is, at an input side, connected to a boom's operation detection means 50 for detecting an operating direction and operation amount of a boom manipulator, a swiveling's operation detection means 51 for detecting an operating direction and operation amount of a swiveling manipulator, a stick's operation detection means 52 for detecting an operating direction and operation amount of a stick manipulator, a bucket's operation detection means 53 for detecting an operating direction and operation amount of a bucket manipulator, a traveling's operation detection means 54 for detecting an operation direction and operation amount of a traveling manipulator, and a plurality of pressure sensors respectively for detecting, not shown in figures, discharge pressure of hydraulic pumps P1, P2 and load pressure of each hydraulic actuator (the boom cylinder 6, the swiveling motor 7, the stick cylinder 8, the bucket cylinder 9, and the left and right traveling motors 4 and 5); and at an output side, connected to the boom's, swiveling's, stick's, and bucket's directional switching valves 23 to 26, the boom's extended side and contracted side proportional solenoid valves 41a, 41b, the swiveling's left swiveling side and right swiveling side proportional solenoid valves 42a, 42b, the stick's extended side and contracted side proportional solenoid valves 43a, 43b, the bucket's extended side and contracted side proportional solenoid valves 44a, 44b, the left traveling forward and backward proportional solenoid valves 47a, 47b, the right traveling forward and backward proportional solenoid valves 48a, 48b, the stick flow rate control proportional solenoid valve 45 outputting pilot pressure to the stick's flow rate control valve 28 disposed on the stick's subside supply oil passage 18, the boom flow rate control proportional solenoid valve 46 outputting pilot pressure to the boom's flow rate control valve 29 disposed on the boom's subside supply oil passage 20, the traveling straight-forward valve 11, and variable-capacity means P1a, P2a of the hydraulic pump P1, P2, which respectively output to pilot pressure to the pilot ports 23a, 23b-26a, 26b, 13a, 13b, 14a, 14b of the boom's, swiveling's, stick's, bucket's directional switching valves 23-26 and the left and right traveling directional switching valves 13, 14. The controller 10 can freely control the input to/output from the prime motor control device. Further, the controller 10 includes various setting units and control units, such as a reference pump flow rate setting unit (corresponding to a reference pump flow rate setting means of the present invention) 61, a target supply flow rate setting unit 62, a supply flow rate control unit 63, a target pump flow rate setting unit (corresponding to a target pump flow rate setting means of the present invention) 64, and a pump flow rate control unit (including a pump capacity control unit 65a and a prime motor rotational speed control unit 65b, corresponding to a pump flow rate control means of the present invention) 65. The setting units and the control units are configured to perform oil supply and discharge control of each of the hydraulic actuators 4 to 9, capacity control of the hydraulic pumps P1 and P2, and rotational speed control of the prime motor M, and the like.

Next, control performed by each setting unit, control unit 61-65 of the controller 10 will be described.

First, in the reference pump flow rate setting unit 61, the controller 10 sets the pump flow rate of the hydraulic pumps P1 and P2 as the reference pump flow rate Ls when the pump capacity of the hydraulic pumps P1 and P2 is the maximum and the rotational speed of the prime motor M is the preset reference rotational speed Ns. In this case, during normal operation of the hydraulic excavator, the use rotational speed range of the prime motor M is set in advance, and the reference rotational speed Ns is set to a speed within the use rotational speed range and less than the maximum rotational speed Nm within the use rotational speed range. The reference pump flow rate Ls is to be integrated into the reference pump flow rate setting unit 61 as a control parameter, and can be changed, for example, using a monitoring device (not shown) arranged in the cab of the hydraulic excavator 1.

Furthermore, the pump flow rate of the hydraulic pumps P1 and P2 is set as the maximum pump flow rate Lm of each hydraulic pump P1 and P2 when the capacity of the hydraulic pumps P1 and P2 is the maximum and the rotational speed of the prime motor M is the maximum rotational speed Nm.

Furthermore, the controller 10 sets the target supply flow rate for each hydraulic actuator in the target supply flow rate setting unit 62 and sets the target pump flow rate Lt of the hydraulic pumps P1 and P2 in the target pump flow rate setting unit 64 when a detection signal is input from the respective operation detection means 50 to 54 for the boom, swiveling, stick, bucket, and traveling.

The target supply flow rate setting unit 62 sets a target supply flow rate supplied to each hydraulic actuator from each hydraulic pump P1, P2 according to the combination of hydraulic actuators operated and the operation amount of each manipulator. In this case, the sum of the target supply flow rates supplied from each hydraulic pump P1 and P2 is set to distribute the pump flow rates of the hydraulic pumps P1 and P2 to each hydraulic actuator according to the manipulator operation amount of each hydraulic actuator with the hydraulic pumps P1 and P2 as the hydraulic supply sources, within a range not exceeding the maximum pump flow rate Lm of each hydraulic pump P1 and P2, respectively.

In addition, the target pump flow rate setting unit 64 sets the target pump flow rate Lt of each hydraulic pump P1 and P2 based on the sum of the target supply flow rates to each hydraulic actuator carried by each hydraulic pump P1 and P2 respectively. In this case, the target pump flow rate Lt of each hydraulic pump P1, P2 is set so as not to exceed the preset maximum pump flow rate Lm of each hydraulic pump P1, P2.

Furthermore, in the supply flow rate control unit 63, the controller 10 outputs a control signal to each of the solenoid proportional valves 41a, 41b-44a, 44b, 47a, 47b-48a, 48b, 45, 46 to output pilot pressure for the opening area and to calculate the opening area of the boom's, swiveling's, stick's, bucket's, left and right traveling directional switching valves 23-26, 13, 14 corresponding to the target supply flow rate, such that the target supply flow rate set by the target supply flow rate setting unit 62 is supplied from each hydraulic pump P1, P2 to each hydraulic actuator.

Further, the controller 10 controls the pump capacity of the hydraulic pumps P1 and P2 and the rotational speeds of the prime motor M in the pump flow rate control unit 65 (including a pump capacity control unit 65a that controls the pump capacity of the hydraulic pumps P1 and P2 and a prime motor rotational speed control unit 65b that outputs a control signal to the prime motor controller 60 to control the rotational speed of the prime motor M) so that the pump flow of the hydraulic pumps P1 and P2 is the target pump flow rate Lt set by the target pump flow setting unit 64. In this case, the pump flow rate control unit 65 controls the rotational speed of the prime motor M to be the reference rotational speed Ns when the target pump flow rate Lt of both hydraulic pumps P1 and P2 set in the target pump flow rate setting unit 64 is less than or equal to the reference pump flow rate Ls, and controls the pump capacity so that the pump flow rate of the hydraulic pumps P1 and P2 is the target pump flow rate Lt. On the other hand, when the target pump flow rate Lt of any hydraulic pump P1 or P2 exceeds the reference pump flow rate Ls, the pump capacity of any of the hydraulic pumps P1 and P2 is maximized, and the rotational speed of the prime motor M is increased to greater than the reference revelation rotational speed Ns with the maximum rotational speed Nm as the upper limit, so that the pump flow rate Lt of any of the hydraulic pumps P1 and P2 is controlled to be the target pump flow rate Lt that exceeds the reference pump flow rate Ls. Also, any other of the hydraulic pumps P2 and P1 is controlled to be the target pump flow rate Lt by adjusting the pump capacity according to the increased rotational speeds of the prime motor M.

Next, the control performed by the controller 10 will be specifically described.

For example, when the maximum pump capacity of the hydraulic pumps P1 and P2 is set to 125 cc/rev and the reference rotational speed Ns of the prime motor M is set to 1600 rpm, the reference pump flow rate Ls is set to 200 L/m. Furthermore, if the maximum rotational speed Nm within the normal use rotational speed range of the prime motor M is set to 2400 rpm, the maximum pump flow rate Lm of the hydraulic pumps P1, P2 is set to 300 L/m.

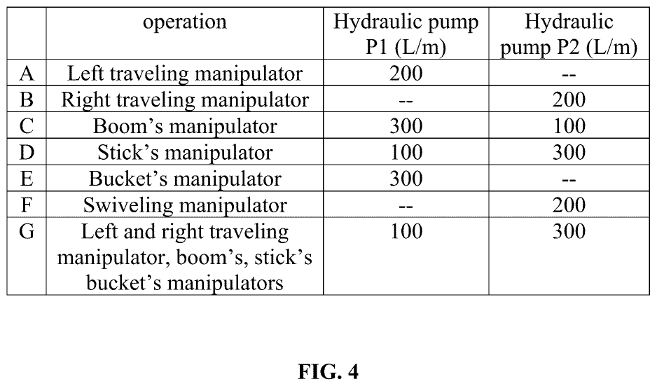

The table of FIG. 4 shows an example of the target pump flow rate Lt of the hydraulic pumps P1 and P2 set when the manipulator for each hydraulic actuator is operated in a case where the reference pump flow rate Ls is set to 200 L/m and the maximum pump flow rate Lm is set to 300 L/m as described above. The “A” to “F” in the table respectively are the target pump flow rates Lt when the left traveling manipulator, the right traveling manipulator, the boom manipulator, the stick manipulator, the bucket manipulator, and the swiveling manipulator are fully operated separately, and the “G” is the target pump flow rate Lt when the left and right traveling manipulator, the boom manipulator, the stick manipulator, and the bucket manipulator are fully operated at the same time. Note that the traveling straight-forward valve 11 is controlled to be located at the first position X in the case of “A” to “F” and at the second position in the case of “G”.

Here, the reference pump flow rate Ls is set to be the same flow rate as the maximum supply flow rate to each of the left and right traveling motors 4, 5 in the present embodiment. The maximum supply flow rate to the left and right traveling motors 4, 5 is set to limit the maximum value of the supply flow rate to the left and right traveling motors 4, 5 so that travel bends do not occur when driving the hydraulic excavator 1 in a straight line. Then, by setting the reference pump flow rate Ls to the maximum supply flow rate to the traveling motors 4 and 5, and setting the target pump flow rate Lt to the reference pump flow rate Ls (200 L/m) when the left and right traveling manipulators are fully operated, as shown in “A” in FIG. 4, the maximum supply flow rate from the hydraulic pumps P1 and P2 to the left and right motors 4 and 5 can be equally supplied when only the left and right traveling manipulators are fully operated at the same time.

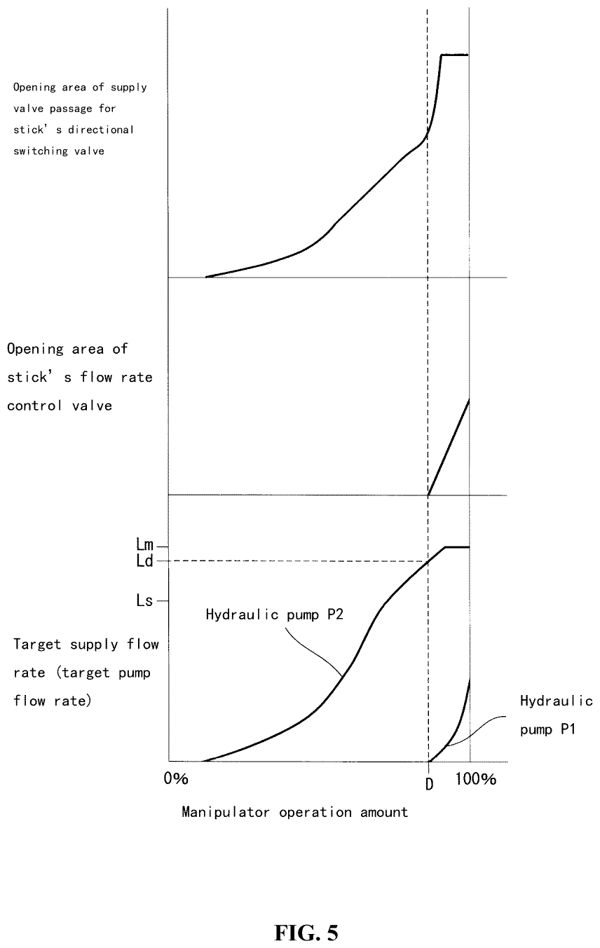

In addition, an example of the target pump flow rate Lt of the hydraulic pumps P1 and P2 when the boom and stick manipulators are fully operated alone is shown in “C” and “D” in FIG. 4. As described above, the boom cylinder 6 and the stick cylinder 8 are large flow rate hydraulic actuators that use both the hydraulic pumps P1 and P2 as the hydraulic sources, and when the boom and stick manipulators are operated alone, the target supply flow rate and the target pump flow rate Lt are set separately for the hydraulic pumps P1 and P2. Regarding the control in this case, the stick cylinder 8 is described based on FIG. 5 as an example since the case of the boom cylinder 6 and the case of the stick cylinder 8 are the same. The controller 10 does not set the target supply flow rate (the target supply flow rate is zero) from the hydraulic pump P1 connecting the stick subside supply oil passage 18, but only sets the target supply flow rate from the hydraulic pump (main pump) P2 connecting the stick's main-side supply oil passage 22 to increase with the increase of the operation amount of the manipulator, controls the opening area of the supply valve passage 25e of the stick's directional switching valve 25 to increase with the increase of the operation amount of the manipulator, and controls the stick's flow rate control valve 28 to be closed. On the other hand, when the operation amount of the manipulator exceeds the set value D, the target supply flow rate from both the hydraulic pumps P2 and P1 is set, and in addition to the supply valve passage 25e of the stick's directional switching valve 25, the stick's flow rate control valve 28 is also controlled to open. The set value D of the operation amount of the manipulator is set to a value exceeding 50% of the operation amount of the manipulator when the operation amount is 100% in a state of fully operating, for example, 70% to 90% of the operation amount, and the target supply flow rate when the operation amount of the manipulator is the set value D is set to the set flow rate Ld, and the set flow rate Ld is set to approach the maximum pump flow rate Lm exceeding the reference pump flow rate Ls of the hydraulic pump P2. As a result, if the flow rate supplied to the stick cylinder 8 is below the set flow rate Ld which is set to exceed the reference pump flow rate Ls, the flow rate to the stick cylinder 8 is supplied the hydraulic oil only from the hydraulic pump P2, and if the flow rate exceeds the set flow rate Ld, the supply flow rate to the stick cylinder 8 is supplied the hydraulic oil from both the hydraulic pumps P1 and P2. Furthermore, the controller 10 sets the target pump flow rate Lt of the hydraulic pumps P2, P1 so that the target supply flow rate can be supplied, but in this case, the target pump flow rate Lt of the hydraulic pump P2 is to be set to exceed the reference pump flow rate Ls according to the target supply flow rate. Then, by setting the target supply flow rate and the target pump flow rate Lt in this way, when the operation amount of the manipulator exceeds the set value D, that is, when the supply flow rate to the stick cylinder 8 exceeds the set flow rate Ld set to exceed the reference pump flow rate Ls, the hydraulic oil from both the hydraulic pumps P2 and P1 is merged and supplied to the stick cylinder 8, so that the frequency at which merging is performed can be reduced.

On the other hand, when the boom manipulator and the stick manipulator are operated at the same time, that is, when the boom cylinder 6 and the stick cylinder 8, which are large flow rate hydraulic actuators, are driven at the same time, the controller 10 calculates the distribution flow rate to the boom cylinder 6 and the stick cylinder 8 according to the operation amount of the manipulators, sets the target supply flow rate to enable the distribution flow rate to be supplied to the boom cylinder 6 and the stick cylinder 8 only from the main hydraulic pumps P1 and P2, respectively, and further sets the target pump flow rate Lt according to the target supply flow rate. That is, only the target supply flow rate from the hydraulic pump P1 is set for the boom cylinder 6, and the target pump flow rate Lt of the hydraulic pump Pl is set according to the target supply flow rate to the boom cylinder 6; and only the target supply flow rate from the hydraulic pump P2 is set for the stick cylinder 8, and the target pump flow rate Lt of the hydraulic pump P2 is set according to the target supply flow rate to the stick cylinder 8. Then, the boom's and stick's directional switching valves 23 and 25 are controlled to open the supply valve passages 23e, 25e at the opening area according to the target supply flow rate, while the boom's and stick's flow rate control valves 29 and 28 are controlled to close. In addition, the pump capacity control of the hydraulic pumps P1 and P2 and the rotational speed control of the prime motor M are carried out so that the pump flow rates of the hydraulic pumps P1 and P2 are respectively the target pump flow rate Lt. In this way, when the boom cylinder 6 and the stick cylinder 8 are driven at the same time, the merging of the discharged oil of the hydraulic pumps P1 and P2 can be eliminated even if these are large flow rate hydraulic actuators supplied with hydraulic oil from both hydraulic pumps P1 and P2 at the time of maximum flow supply.

In addition, an example of the target pump flow rate Lt of the hydraulic pump P1 when the bucket manipulator is fully operated alone is shown in “E” of FIG. 4, but the target pump flow rate Lt is set to be greater than the reference pump flow rate Ls of the hydraulic pump P1. This makes it possible to supply a flow rate exceeding the reference pump flow rate Ls to the bucket cylinder 9 when the bucket operating tool is fully operated alone, and even the bucket cylinder 9 with only one hydraulic pump P1 as the hydraulic supply source can increase the supply flow rate without increasing the capacity of the hydraulic pump P1 to improve the work efficiency.

In addition, an example of the target pump flow rate Lt of the hydraulic pumps P1 and P2 when the left and right traveling manipulators and the boom, stick, and bucket manipulators are fully operated at the same time is shown in “G” of FIG. 4, in which case the traveling straight-forward valve 11 is controlled to be located in the second position Y as described above, so that the left and right traveling motors 4, 5 are supplied with the hydraulic oil from the hydraulic pump P1, and the boom cylinder 6, the stick cylinder 8, and the bucket cylinder 9 are supplied with the hydraulic oil from the hydraulic pump P2. Then, in this case, by setting the target pump flow rate Lt of the hydraulic pump P2 to be greater than the reference pump flow rate Ls, as shown in “G” in FIG. 4, the supply flow rate to the boom cylinder 6, the stick cylinder 8, and the bucket cylinder 9 can be increased, which can contribute to improving work efficiency.

In the present embodiment configured as described, the hydraulic control system of the hydraulic excavator 1 is configured to include a prime motor M, a plurality of variable-capacity hydraulic pumps P1, P2 driven by the prime motor M, and a plurality of hydraulic actuators 4-9 (left and right traveling motors 4, 5, the boom cylinder 6, the swiveling motor 7, the stick cylinder 8, the bucket cylinder 9) driving at least one of the hydraulic pumps P1, P2 as a hydraulic source; operating means for each hydraulic actuator (the left and right traveling manipulator, the boom manipulator, the swivel manipulator, the stick manipulator, the bucket manipulator) operated to drive each hydraulic actuator 4-9, and a plurality of control valves (the traveling straight-forward valve 11, the left and right traveling, boom's, swiveling's, stick's, bucket's directional switching valves 13, 14, 23-26, the boom's, stick's flow rate control valves 28, 29) controlling the supply of hydraulic oil from the hydraulic pumps P1 and P2 to each hydraulic actuator 4-9. Moreover, when the controller 10 is provided to control the operation of the control valve, the pump capacity of the hydraulic pumps P1, P2 and the rotational speed of the prime motor M, the controller 10 includes the reference pump flow rate setting unit 61 that sets the reference pump flow rate Ls as the pump flow rate of the hydraulic pumps P1, P2 when the pump capacity of the hydraulic pumps P1, P2 is the maximum and the rotational speed of the prime motor M is the preset reference rotational speed Ns; the target pump flow rate setting unit 64 that sets, for each of the hydraulic pump, the target pump flow rates Lt of each of the hydraulic pumps P1 and P2s in accordance with operation of an operating means for each of the hydraulic actuators within a range in which the pump flow rates of each of the hydraulic pumps P1 and P2 do not exceed the preset maximum pump flow rate Lm; and the pump flow control section 65 that maximizes the pump capacity of any hydraulic pump P1 or P2 and makes the rotational speed of the prime motor M be greater than the reference rotational speed Ns when the target pump flow Lt of any hydraulic pump P1 or P2 set by the target pump flow setting unit 64 exceeds the reference pump flow Ls, thereby making the pump flow of the hydraulic pump P1 or P2 increase to be greater than the reference pump flow Ls.

However, by controlling the reference pump flow rate setting unit 61, the target pump flow rate setting unit 64, and the pump flow rate control unit 65 provided in the controller 10, the pump flow rate of the hydraulic pump Pl or P2, which is the hydraulic source of the hydraulic actuator operated by the manipulator, can be increased to be greater than the reference pump flow rate Ls when the pump capacity is the maximum and the rotational speed of the prime motor M is the reference rotational speed Ns, so that the need and frequency of merging the discharged oil of the hydraulic pumps P1 and P2 can be reliably reduced to ensure the flow rate supplied to the operated hydraulic actuator, thereby reducing the efficiency, operability, and complexity of the circuit caused by merging. Moreover, since the configuration increases the pump flow of the hydraulic pumps P1 and P2 to be greater than the reference pump flow rate Ls by increasing the rotational speed of the prime motor M to be greater than the reference rotational speed Ns, it is unnecessary to provide a large-capacity hydraulic pump.

Furthermore, in the present embodiment, while the hydraulic pump P1 and the hydraulic pump P2 (the first and second hydraulic pumps) are provided as hydraulic pumps, and the boom cylinder 6 and the stick cylinder 8 (high flow rate hydraulic actuator) are provided as hydraulic actuator, which are supplied with the hydraulic oil from both the hydraulic pumps P1 and P2 at the time of maximum flow supply. On the other hand, when the boom and stick manipulators are independently operated, the controller 10 controls one of the hydraulic pumps P1 and P2 as the main pump to supply hydraulic oil only from the main pump until the supply flow rate to the boom cylinder 6 and the stick cylinder 8 reaches the set flow rate Ld which is set to exceed the reference pump flow rate Ls, and when the set flow rate Ld is exceeded, controls the hydraulic oil to be supplied from the two hydraulic pumps P1 and P2; and the target pump flow rate setting unit 64 sets the target pump flow rate Lt of the main pump to exceed the reference pump flow rate Ls according to the supply flow rate from the main pump to the boom cylinder 6 and the stick cylinder 8. This means that only when the flow rate supplied to the boom cylinder 6 and the stick cylinder 8 exceeds the set flow rate Ld which is set to exceed the reference pump flow rate Ls, the hydraulic oil from both the hydraulic pumps P1 and P2 is merged and supplied to the boom cylinder 6 and the stick cylinder 8, so that even a large flow rate hydraulic actuator is supplied with the hydraulic oil from both the hydraulic pumps P1 and P2 at the time of maximum flow rate supply, the frequency of merging can be reduced.

Furthermore, in the present embodiment, the boom cylinder 6 uses the hydraulic pump P1 as the main pump, and the stick cylinder 8 uses the hydraulic pump P2 as the main pump. However, when the boom manipulator and the stick manipulator are operated at the same time, the controller 10 controls the boom cylinder 6 and the stick cylinder 8 to be supplied with the hydraulic oil only from the main pump, and the target pump flow setting unit 64 sets the target pump flow rate Lt of the hydraulic pumps P1 and P2 for the hydraulic pump according to the operation amount of the boom and the stick manipulators. As a result, when the boom cylinder 6 and the stick cylinder 8 are driven at the same time, the merging of the discharged oil of the hydraulic pumps P1 and P2 can be eliminated even if these are large flow rate hydraulic actuators with both the hydraulic pumps P1 and P2 as the hydraulic oil source at the time of maximum flow supply.

In addition, the hydraulic excavator 1 comprises a traveling body (the lower traveling body 71 and the upper swivel body 72) including left and right traveling bodies, and a working device (the front working machine 73) mounted on the traveling body, and comprises the hydraulic pump P1 and the hydraulic pump P2 as hydraulic pumps, and the left and right traveling motors 4 and 5 that respectively drive the left and right traveling bodies as hydraulic actuators. On one hand, the hydraulic excavator includes the boom cylinder 6, the stick cylinder 8, and the bucket cylinder 9 as a plurality of working hydraulic actuators driving the working device. On the other hand, when the left and right traveling manipulator, the boom, stick, and bucket manipulators are operated at the same time, the controller 10 controls the traveling straight-forward valve 11 to supply the hydraulic oil from the hydraulic pump P1 to the left and right traveling motors 4 and 5, and to supply the hydraulic oil from the hydraulic pump P2 to the boom cylinder 6, the stick cylinder 8, and the bucket cylinder 9, and the target pump flow rate setting unit 64 sets the target pump flow rate Lt of the hydraulic pump P2 to be greater than the reference pump flow rate Ls. As a result, the left and right traveling motors 4, 5 and the working hydraulic actuator (the boom cylinder 6, the stick cylinder 8, the bucket cylinder 9) can be supplied with hydraulic oil independently without hydraulic interference from each other, and by setting the target pump flow rate Lt of the hydraulic pump P2 to be greater than the reference pump flow rate Ls, the supply flow rate to the working hydraulic actuator can be increased, which can contribute to improving work efficiency.

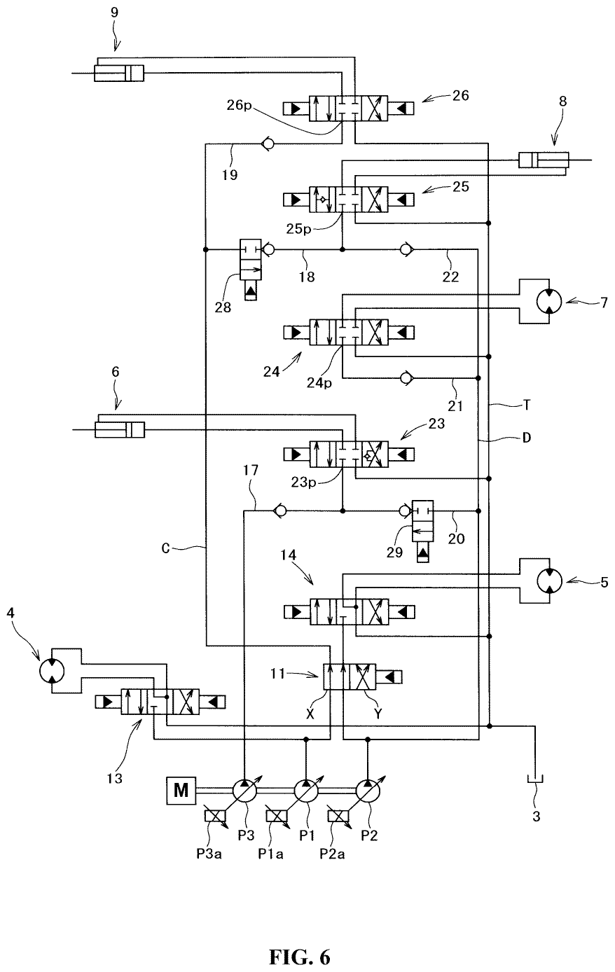

A second embodiment of the present invention will be described below with reference to FIG. 6. In the second embodiment, the same reference numerals are assigned to the parts common to the first embodiment and the description is omitted.

In the second embodiment, three hydraulic pumps, P1, P2, and P3, are provided as hydraulic pumps driven by the prime motor M. Also, the hydraulic pump P1, as in the first embodiment, is connected to the pump line C via the traveling straight-forward valve 11 which is located at the first position, and is connected to the left traveling directional switching valve 13. Also, the hydraulic pump P2 is connected to the pump line D, and is connected to the right traveling directional switching valve 14 via the traveling straight-forward valve 11 which is located at the first position X. On the other hand, the hydraulic pump P3 is connected to the boom's main-side supply oil passage 17.

From the pump line C connected to the hydraulic pump P1, the stick's subside supply oil passage 18 and the bucket's supply oil passage 19 are branched in parallel with each other, and from the pump line D connected to the hydraulic pump P2, the boom's subside supply oil passage 20, the swiveling's supply oil passage 21, and the stick's main-side supply oil passage 22 are branched in parallel with each other. The stick's subside supply oil passage 18 and the boom's subside supply oil passage 20 are respectively provided with the stick's flow rate control valve 28 and the boom's flow rate control valve 29, as in the first embodiment.

The hydraulic oil from the hydraulic pump P3 is supplied via the boom's main-side supply oil passage 17 and the hydraulic oil from the hydraulic pump P2 is supplied via the boom's subside supply oil passage 20 to the pump port 23p of the boom's directional switching valve 23, and the hydraulic oil from the hydraulic pump P2 is supplied to the boom's directional switching valve 23 in a state (including a cut-off state) in which the flow rate is controlled by the boom's flow control valve 29 provided in the boom's subside supply oil passage 20. Further, the hydraulic oil from the hydraulic pump P2 is supplied via the stick's main-side supply oil passage 22 and the hydraulic oil from the hydraulic pump P1 is supplied via the stick subside supply oil passage 18 to the pump port 25p of the stick's directional switching valve 25, and the hydraulic oil from the hydraulic pump P1 is supplied to the stick's directional switching valve 25 in a state (including a cut-off state) in which the flow rate is controlled by the stick's flow rate control valve 28 provided in the stick's subside supply oil passage 18. Further, the hydraulic oil from the hydraulic pump P1 is supplied to the pump port 26p of the bucket's directional switching valve 26 via the bucket's supply oil passage 19, and the hydraulic oil from the hydraulic pump P2 is supplied to the pump port 24p of the swiveling's directional switching valve 24 via the swiveling's supply oil passage 21. The boom's, swiveling's, stick's, bucket's directional switching valves 23 to 26, and the boom's and stick's flow control valves 29 and 28 are the same as those in the first embodiment.

And in the second embodiment, as in the first embodiment, the oil supply and discharge control of each hydraulic actuator 4 to 9, the capacity control of the hydraulic pumps P1, P2, P3, the rotational speed control of the prime motor M, etc. are carried out by the controller 10, but in the second embodiment, the hydraulic pump P3 is the hydraulic supply source of the boom cylinder 6 only. Then, when the boom manipulator, the stick manipulator, and the bucket manipulator are operated at the same time, i.e., the so-called front triple complex operation, the controller 10 controls to close the boom's and stick's flow rate control valves 29, 28, respectively. As a result, during the front triple complex operation, the boom cylinder 6 is supplied with the hydraulic oil only from the hydraulic pump P3, the stick cylinder 8 is supplied with the hydraulic oil only from the hydraulic pump P2, and the bucket cylinder 9 is supplied with the hydraulic oil only from the hydraulic pump P1, so that the boom cylinder 6, the stick cylinder 8, and the bucket cylinder 9 can be supplied with the hydraulic oil in an independent circuit without hydraulic interference from each other. In this case, the pump flow rates of the hydraulic pumps P3, P2, and P1 can be controlled to increase or decrease by the pump capacity control and the rotational speed control of the prime motor M according to the operation amounts of the boom, stick, and bucket manipulators, so that the pump flow rates of each of the hydraulic pumps P3, P2, and P1 can be a flow rate corresponding to the operation amounts of the manipulators of the boom cylinder 6, the stick cylinder 8, and the bucket cylinder 9.

It should be noted that the present invention is not limited to the first and second embodiments described above, and for example, in setting the target pump flow rate of each hydraulic pump, it can be configured to set an upper limit to the sum of the target pump flow rates of all hydraulic pumps. In this case, the upper limit of the sum of the target pump flow rates can be arbitrarily set in a range not exceeding the sum of the maximum pump flow rates of each hydraulic pump. In addition, in the above embodiment, an electric motor is used as the prime motor, but the present invention can be implemented even if an engine is used as the prime motor.

Further, this invention can obviously be implemented to various working machines with a plurality of hydraulic pumps driven by the prime motor without being limited to hydraulic excavator.

### Industrial Applicability

This invention can be used in the hydraulic control system of a working machine such as hydraulic excavator.

1. A hydraulic control system of a working machine, characterized in comprising a prime motor, a plurality of variable-capacity hydraulic pumps driven by the prime motor, a plurality of hydraulic actuators driving at least one of the hydraulic pumps as a hydraulic source, operating means for each hydraulic actuator operated to drive each hydraulic actuator, and a plurality of control valves controlling supply of hydraulic oil from the hydraulic pump to each hydraulic actuator,
and providing a controlling device to control actuation of the control valve, pump capacity of the hydraulic pump and a rotational speed of the prime motor;
wherein the controlling device comprises:
a reference pump flow rate setting means that sets a pump flow rate of the hydraulic pump when the pump capacity of the hydraulic pump is a maximum and the rotational speed of the prime motor is a preset reference rotational speed as a reference pump flow rate;
a target pump flow rate setting means that sets a target pump flow rate of each hydraulic pump for each hydraulic pump depending on operation of the operating means for each hydraulic actuator within a range in which the pump flow rate of each hydraulic pump does not exceed a preset maximum pump flow rate; and
a pump flow rate control means that, when the target pump flow rate of any one of the hydraulic pumps set by the target pump flow rate setting means exceeds the reference pump flow rate, maximizes the pump capacity of the one of the hydraulic pumps and increases the rotational speed of the prime motor to be greater than the reference rotational speed, thereby increasing the pump flow rate of the one of the hydraulic pumps to be greater than the reference pump flow rate.

2. The hydraulic control system in the working machine according to claim 1, characterized in that,
a first hydraulic pump and a second hydraulic pump are comprised as the hydraulic pumps, and a large flow rate hydraulic actuator supplied hydraulic oil from both the first and second hydraulic pumps at a time of maximum flow rate supply is comprised as the hydraulic actuator;
the controller controls any one of the first and second hydraulic pumps to a main pump and supply hydraulic oil from only the main pump until a flow rate supplied to the large flow rate hydraulic actuator reaches a set flow rate which is set to exceed the reference pump flow rate, when the operating means for the large flow rate hydraulic actuator is operated alone, and to be supplied with the hydraulic oil from both the first and second hydraulic pumps when the flow rate exceeds the set flow rate; and
the target pump flow rate setting means sets the target pump flow rate of the main pump to exceed the reference pump flow rate depending on the supply flow rate to the large flow rate hydraulic actuator from the main pump.

3. The hydraulic control system in the working machine according to claim 2, characterized in that,
a first large flow rate hydraulic actuator is comprised, using the first hydraulic pump as the main pump, and a second large flow rate hydraulic actuator is comprised, using the second hydraulic pump as the main pump;
when the operating means for the first and second large flow rate hydraulic actuators are operated simultaneously, the controller controls to supply the hydraulic oil from each main pump to the first and second large flow rate hydraulic actuators, respectively; and
the target pump flow rate setting means sets the target pump flow rate of the first and second hydraulic pumps for each hydraulic pump depending on the operation amount of the operating means for the first and second large flow rate hydraulic actuators.

4. The hydraulic control system in the working machine according to claim 1, characterized in that,
the work machine comprises a traveling body having a left traveling body and a right traveling body, a working device mounted on the traveling body, a first hydraulic pump and a second hydraulic pump as the hydraulic pumps, a left traveling motor and a right traveling motor, as the hydraulic actuators, driving the left traveling body and the right traveling body, respectively, and a plurality of working hydraulic actuators driving the working device;
when the left and right travel motors and the operating means for the working hydraulic actuator are simultaneously operated, the controller controls a control valve to supply the hydraulic oil from the first hydraulic pump to the left and right traveling hydraulic motors and the hydraulic oil from the second hydraulic pump to the working hydraulic actuator; and
the target pump flow rate setting means sets the target pump flow rate of the second hydraulic pump to be greater than the reference pump flow rate.
